(19) United States
(12) Patent Application Publication
(10) Pub. No.: US 2004/0227681 A1
(43) Pub. Date: Nov. 18, 2004

(54) Signal receiving antenna for the system of GPS etc.

(75) Inventor: Sheng Ming Deng, Hsinchu City (TW)

Correspondence Address: BRUCE H. TROXELL, SUITE 1404, 5205 LEESBURG PIKE, FALLS CHURCH, VA, 22041, US

(73) Assignee: Inpaq Technology Co., Ltd.

(21) Appl. No.: 10/437,237

(22) Filed: May 14, 2003

(51) Int. Cl. H01Q 11/12

(52) U.S. Cl. 343/742; 343/867

(57) ABSTRACT

A signal receiving antenna suitable for the system of GPS etc., it forms a metallic conductor on a thin film of carrier, the main construction of said metallic conductor includes a plurality of loops; if the carrier is made of metal, then the loop on the carrier is formed as a furrow and only a main loop includes input terminals; such that the loop forms an unsymmetrical structure and the functions of wider band and/or wider circular polarization are obtained.

### BACKGROUND OF THE INVENTION

1. Field of the invention

The present invention relates to an antenna, especially to an antenna having two or more loops of antenna conductor, such that it can produce the functions of wider band and/or wider circular polarization. Then it is suitable for the antenna of wider band and/or wider circular polarization.

2. Description of the Prior Art

The present invention is a signal receiving antenna which is suitable for the global position system (GPS) etc. used in a car.

At present time, the GPS antenna used in a car is shown as in FIG. 1A, the radiation portion 11 is formed by a spiral coil and then enveloped by a pipe 10, its bottom end is formed as a base seat 12, the related conductor, the matching circuit and feeding portion are formed inside the base seat 12. Said coil antenna, if it is formed as a pole, the length of the radiation portion 11 has to be equal to a wavelength, it must be very high and has large limitations in uses. Especially, if it is used in a car, no matter whether it is located on the car body, or the front/back window of the car, it becomes unexpectedly and abruptly lofty, it then causes inconvenience to the actions of car. Also, it reduces the beauty of a car.

In order to resolve the above problems caused by said conventional coil antenna, a ceramic patch antenna as shown in FIG. 1B then was created. It is about 4 mm in length and 25 mm×25 mm in surface area. Because the ceramic patch antenna is obviously smaller than said conventional coil antenna, then it has gradually occupied the market of conventional coil antenna.

It can be seen that the ceramic patch antenna is light in weight, thin in thickness, short in length, and small in size. However, it still has problems for attaching to the front or back window of a car as follows: first, it still has considerable thickness and weight, then it is difficult to firmly attach to the window of the car. Second, it has to be connected to ground, and then it would shield some portions of the front/or back window. Third, it is not beautiful. Fourth, the main radiation portion 21 and the portion of feeding and matching conductor 22 generally are not formed on a plane. Consequently, in manufacturing this kind of antenna, the error of thickness and the aligning of different planes have to be considered.

In addition, said GPS antennas are not able to produce the functions of wider band and/or wider circular polarization. This is also a common disadvantage of said antennas.

### SUMMARY OF THE INVENTION

Accordingly, it is an object of the present invention to provide a signal receiving antenna for the system of GPS etc. It uses a thin soft film as carrier, and it is formed by a layer of metallic conductor coated on the carrier. It then has the advantages of transparent, light in weight, small in size, and thin in thickness. It provides good functions on the car's windows, such as: it would not cause inconvenience to the actions of a car, and it also would not influence the beauty of a car.

According to the signal receiving antenna for the system of GPS etc. of present invention, because it has the advantages of transparent, light in weight, small in size and thin in thickness. It is easy to be attached firmly onto the car's window, and then it is very convenient in uses. This is another object of present invention.

According to the signal receiving antenna of the system of GPS etc. of present invention, its main radiation portion and the portion of feeding and matching conductor are formed on a same plane, and the carrier is very thin (its thickness is under 0.1 mm). The problems of error and aligning the conductors happened in manufacturing above-mentioned conventional antenna won't be occurred. It is then another object of present invention.

According to the signal receiving antenna for the system of GPS etc. of present invention, no ground connection plate is required. When it is attached to a car's window, it won't influence the driver's sight view. It then has high practicality. It is also an object of present invention.

According to the signal receiving antenna for the system of GPS etc. of present invention, since it can form the functions of wider band and/or wider circular polarizations. It then can be suitable for circular polarization antennas of wider bands.

A more complete understanding of these and other features and advantages of the patent invention will become apparent from a careful consideration of the following detailed description of certain embodiments illustrated in the accompanying, drawings.

### BRIEF DESCRIPTION OF THE DRAWINGS

FIG. 1A & FIG. 1B are perspective views showing two examples of conventional signal receiving antenna of GPS System.

FIG. 2 is a perspective view showing a preferred embodiment of the antenna of present invention.

FIG. 3 is a complementary illustration of the embodiment of FIG. 2.

FIG. 4 is a perspective view showing a preferred embodiment of the antenna of present invention.

FIG. 5 is a perspective view showing another preferred embodiment of the antenna of present invention.

FIG. 6 is a perspective view showing the practical sizes of the preferred embodiment of FIG. 1.

FIG. 7 is a diagram showing the voltage standing wave ratio of the preferred embodiment of FIG. 6.

FIG. 8 is a diagram showing the axial ratio of the preferred embodiment of FIG. 6.

FIG. 9 is a diagram showing the field type of the preferred embodiment of FIG. 6.

### DETAILED DESCRIPTION OF THE PREFERRED EMBODIMENTS

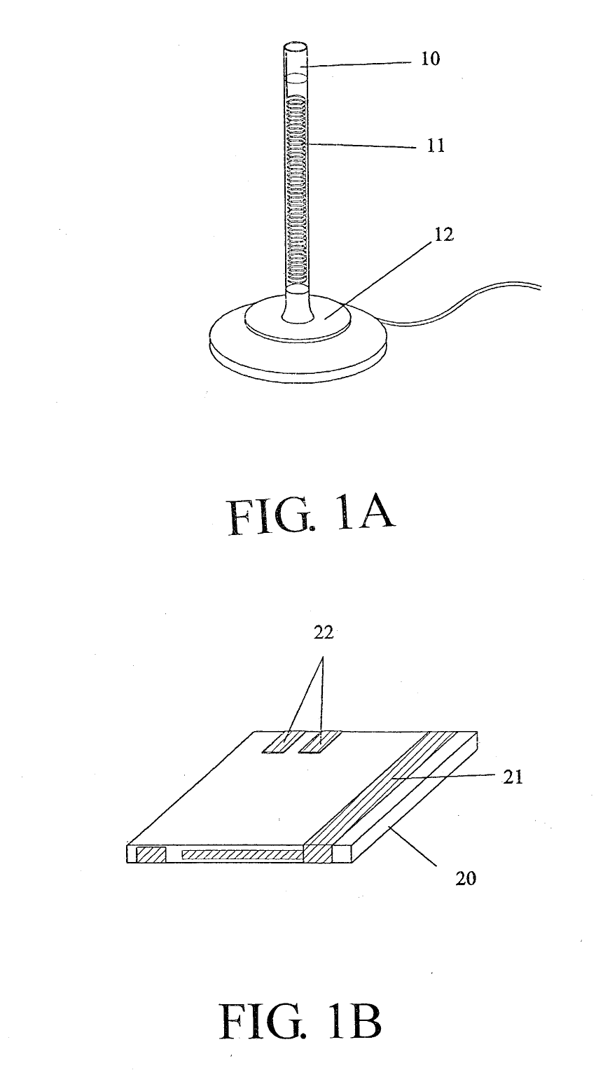

FIGS. 1A and 1B are perspective views showing two examples of conventional signal receiving antenna of GPS system. Their constructions and disadvantages have been described as above, and not been repeated herewith.

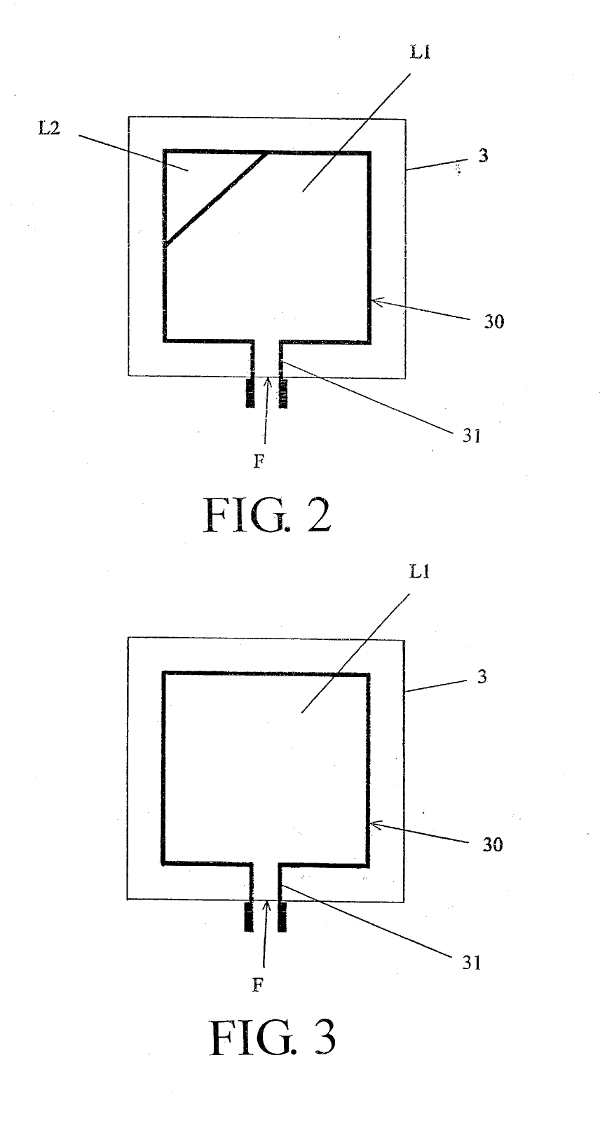

As shown in FIG. 2, it clearly can be obviously be seen that the present invention comprises mainly a thin film of carrier 3 and a metallic antenna conductor 30. Wherein, said metallic antenna conductor 30 includes a radiation portion 31 formed of two loops of metallic conductor L1 and L2. Consequently, if looking inside from feeding terminal F, the whole construction is not symmetrical.

### Illustration of Forming Circular Polarization by Using the Above Shown Embodiment

As to a loop-shaped antenna, if it is formed in a shape as shown in FIG. 3, there is a radiation portion formed by a loop-shaped metallic conductor and a feeding and matching portion. If it is seen from the feeding terminal F of the metallic antenna conductor 30, the whole construction of antenna is symmetrical; therefore, it call only generate linear polarization, and the circular polarization cannot be generated.

There are the conditions for producing circular polarization, one condition is that the length of the loop-shaped metallic antenna conductor must be equal to the wavelength; another condition is that the construction must be unsymmetrical corresponding to the feeding terminal.

As to the present invention shown in FIG. 2, it includes two loops of metallic conductor, one is bigger, the another one is smaller, it is then not a symmetrical construction corresponding to the feeding terminal F, and the center of small loop is located at 3/8 λ of the bigger loop. That is, between the region of ¼ wavelength and ½ wavelength. Consequently, we can see that the electric current is divided into left and right streams, wherein the left stream meets said small loop of metallic conductor L2 after it passes ¼ of wavelength. After that, the electric current divides into three branch currents, that is, one reflection current and two penetration currents, and then to meet together to form an electric current having the functions of reflection and penetration. While the right current meets the small loop of metallic conductor L2 after it passes 2/4 of wavelength, and after that, it also divides into three branch currents, that is, one reflection current and two penetration currents. At this stage, if looking into the metallic antenna conductor 30 from the feeding terminal F, an even symmetrical current and an odd symmetrical current would be generated. Therefore, after a section of input length is added to reflect the even symmetrical current by adjusting the circular polarization and input resistance, the construction, after it is suitably arranged, would generate the function of circular polarization. That is to say, the current phase angles of the four sides of said big loop of metallic conductor L1 have phase differences of 0°, 90°, 180°, and 270° respectively, while the length of feeding terminal has the effects of matching and adjusting circular polarization.

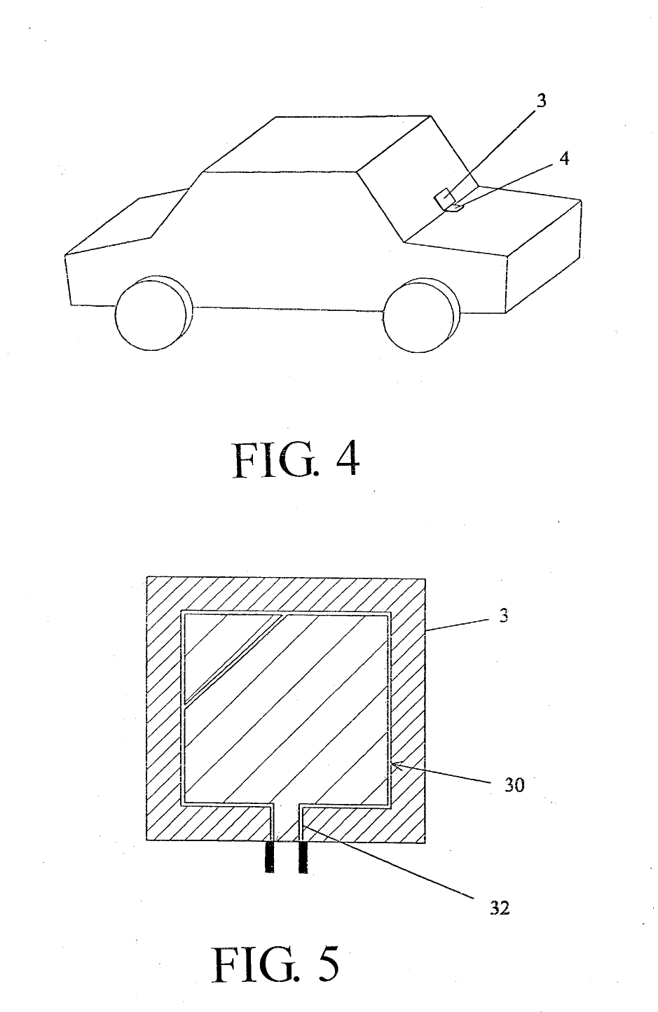

As shown in FIG. 4, in using the signal receiving antenna for the system of GPS etc. of the present invention, it is connected with a low noise amplifier 4 to form an active PS antenna. Since it is very light and easy to be attached, it then can be used to attach onto the back window of a car. In practical uses, it composes the features of wide band resistance matching and wide band circular polarization. It then can be used in Global System for Mobil Communications or other systems.

As shown in FIG. 5, if the carrier 3 of the signal receiving antenna is a metallic film, the main conductor 30 of antenna can be formed as a furrow.

### EXAMPLE

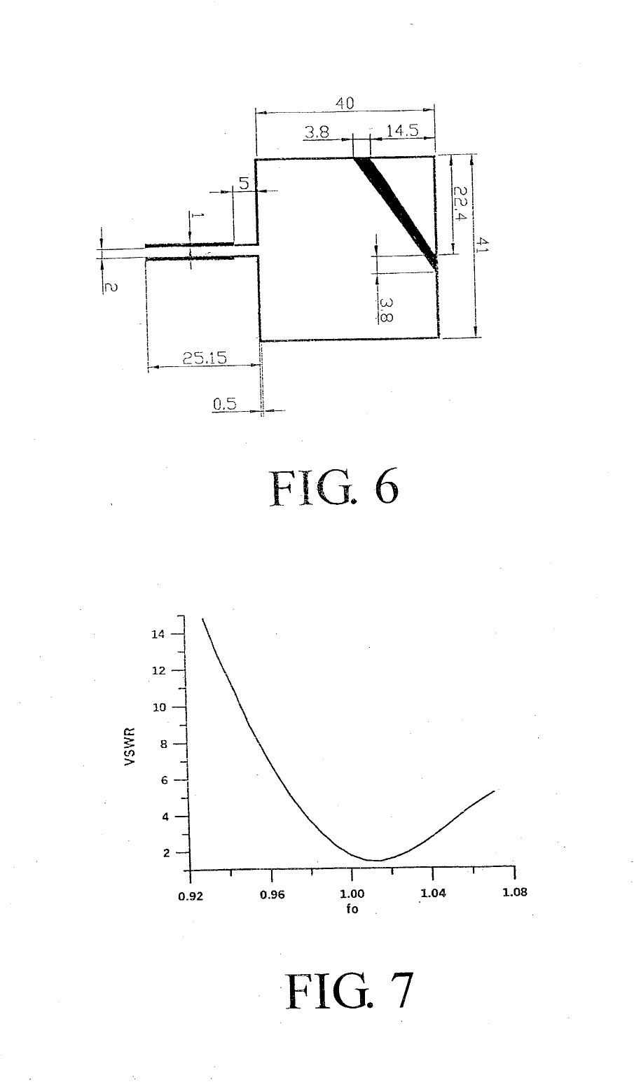

The antenna of present invention can be made with the sizes shown in FIG. 6, wherein the unit is mm, the thickness of antenna is 1.6 mm and the relative medium factor is 4.26.

As shown in FIG. 7, the voltage standing wave ratio (VSWR) measured in FIG. 1 shows that around the normalized central frequency (fₒ=1.0), the VSWR value is low, it then shows that the present invention has excellent radiation effect.

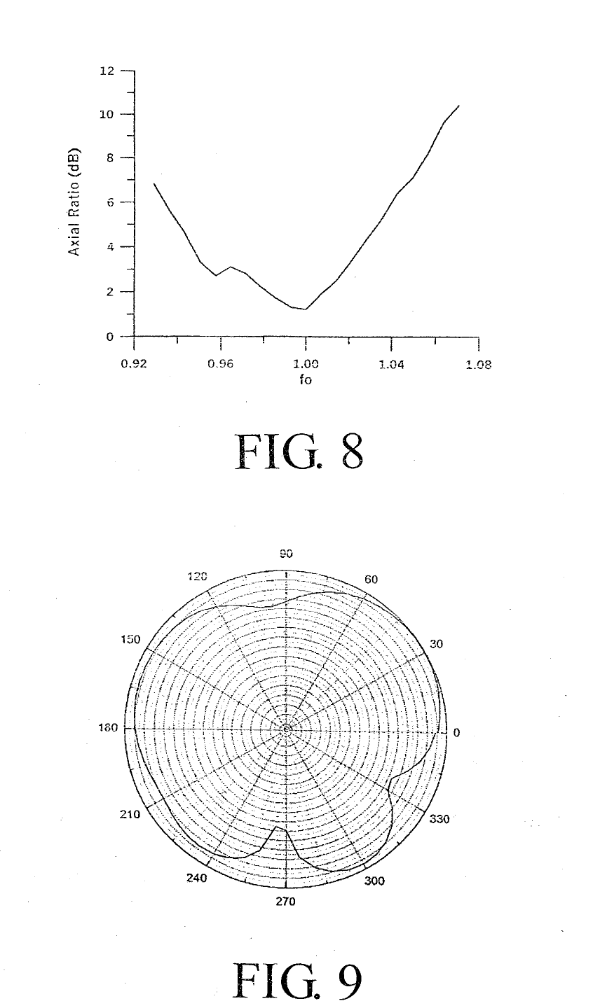

Please also refer to FIG. 8, it shows that the field type measured in X-Y plane of FIG. 1 of present invention is very similar to a circle.

From the above descriptions, it can be seen that the antenna of present invention exhibits a plurality of functions shown above, while the functions would improve the disadvantages of conventional antennas, it is then an invention which meets conditions of approvable patent.

Although the present invention has been described with a certain degree of particularity, the present disclosure has been made by way of example and changes in details of structure may be made without departing from the spirit thereof.

What is claimed is:

1. A signal receiving antenna for the system of GPS etc. comprising:
a thin film of carrier, and
a metallic conductor formed on the carrier;
characterized in that, said metallic conductor of antenna includes at least two loops, and the main loop includes a feeding terminal; such that the loops of metallic conductor are unsymmetrical.

2. The signal receiving antenna for the system of GPS etc. as claimed in claim 1, wherein the thin film of carrier is a thin soft film.

3. The signal receiving antenna for the system of GPS etc. as claimed in claim 1, wherein the carrier is made of a thin metallic film and the antenna body is formed as a furrow.

4. The signal receiving antenna for the system of GPS etc. as claimed in claim 1, wherein the antenna body includes a main loop and a closed sub-loop formed onto said main loop.

5. The signal receiving antenna for the system of GPS etc. as claimed in claim 4, wherein said sub-loop occupies an area smaller than a quarter of main loop.

6. The signal receiving antenna for the system of GPS etc. as claimed in claim 3, wherein the antenna body includes a main loop and a closed sub-loop formed onto said main loop.

7. The signal receiving antenna for the system of GPS etc. as claimed in claim 6, wherein said sub-loop occupies an area smaller than a quarter of main loop.
